(19) United States
(12) Patent Application Publication
(10) Pub. No.: US 2005/0014535 A1
(43) Pub. Date: Jan. 20, 2005

(54) System and method for speaker-phone operation in a communications device

(76) Inventors: Pratik Desai, Boca Raton, FL (US); Ali Behboodian, Plantation, FL (US); Chin Pan Wong, Coral Springs, FL (US)

Correspondence Address: Scott M. Garrett;Motorola, Inc., Law Department, 8000 West Sunrise Boulevard, Fort Lauderdale, FL, 33322, US

(21) Appl. No.: 10/623,427

(22) Filed: Jul. 18, 2003

(51) Int. Cl. H04M 1/00

(52) U.S. Cl. 455/569.1; 455/517; 455/345

(57) ABSTRACT

The invention provides a cellular telephone or other communications device with intelligence to manage speakerphone operation to more nearly approximate normal conversation, even when using a one-way only transmission mode. The microphone path and speaker path may be continuously monitored using dual voice activity detectors to assess the energy and other characteristics of each channel, and switch between one or the other depending on dynamic criteria. In noisy environments, a hangtime may be applied before permitting switching to avoid premature dropouts. Other criteria used to trigger the seizure of the channel may be adjusted, such as to eliminate a lower threshold below which the speaker path switches out automatically.

### FIELD OF THE INVENTION

The invention relates to the field of communications, and more particularly to techniques for generating clearer and more reliable speakerphone operation in a cellular telephone or other communications device.

### BACKGROUND OF THE INVENTION

Convenient and effective speakerphone operation has become a desirable feature in cellular handsets and other communications devices. Communities concerned with traffic safety have in some instances banned the handheld operation of cellular phones while driving. Handsets and other devices equipped with a speakerphone feature permit users to place the device in a resting position in a car or other location while still carrying out normal conversations and other telephone access.

However, equipping a cellular telephone with an effective speakerphone capability is not a trivial integration task. One practical difficulty is that many cellular telephones are small devices which contain both an earpiece speaker and integrated microphone within a few inches of each other, to make the unit more compact. Therefore, duplex-type operation where both the speaker path and microphone path are active at the same time may generate unwanted feedback, since the output of the speaker leaks into the microphone via air and case vibration. This feedback problem only gets worse as speaker volumes are increased, such as they might be in a noisy car or room.

Echo canceling circuits are known which can be connected to the microphone path on a cellular phone or other device, and remove a portion of the feedback energy emanating from the speaker. Unfortunately, echo canceling circuits are currently only capable of about 35 dB of cancellation, and the energy from the speaker may be more than 35 dB greater than the energy delivered by the embedded microphone so that echo and feedback still occur, even when echo cancellation circuits are included.

One solution to the speakerphone problem is to attempt to physically isolate the speaker and microphone from each other in the handset. For instance, one may place the speaker used for speakerphone operation in a rear-facing part of the handset so that less sound impinges directly on the microphone from the speaker. However, this placement makes the sound harder to hear for a user from whom the speaker faces away, and some amount of speaker energy will still leak through the cellular or other case to the microphone.

Another solution to feedback is to prevent the speaker path and microphone path from operating at the same time. This simplex-type of operation makes direct feedback impossible but results in one-way communication only, which requires users at both ends to signal the end of their speech, and wait for a response. More effective and natural speakerphone operation is desirable. Other problems exist.

### SUMMARY OF THE INVENTION

The invention overcoming these and other problems in the art relates in one regard to a system and method for speakerphone operation in a communications device, in which built-in intelligence simultaneously manages both the speaker path and the microphone path of the device to reduce unwanted echo and feedback while still preserving a perceived quality of conversational speech. In an embodiment of the invention, a communications device such as a cellular telephone handset or other device may incorporate dual voice activity detection circuits to simultaneously monitor the signal energy and other characteristics in both speaker and microphone paths, and award control to one or the other path based on dynamic thresholds or other adaptive or other criteria. In other embodiments, problems such as premature dropouts caused by greater than average background noise may be prevented by applying hangtime parameters which keep the speaker path open until a minimum interval has passed, before transferring control to the microphone path. The criteria applied to trigger a change in control from speaker path to microphone path and vice versa may also be adapted in embodiments of the invention, including to eliminate a lower threshold below which the speaker path switches out and passes control to the microphone path, automatically.

### BRIEF DESCRIPTION OF THE DRAWINGS

The invention will be described with reference to the accompanying drawings, in which like elements are referenced with like numbers, and in which:

FIG. 1 illustrates a two-way communications platform including speakerphone operation, according to an embodiment of the invention.

FIGS. 2(A)-2(C) illustrate processing of inbound and outbound speech in different regards, according to an embodiment of the invention.

FIG. 3 illustrates a speakerphone control operation, according to an embodiment of the invention.

FIGS. 4(A) and 4(B) illustrate processing of inbound and outbound speech in different regards, according to an embodiment of the invention.

FIG. 5 illustrates inbound and outbound speech envelopes, according to an embodiment of the invention.

FIG. 6 illustrates a dynamic inbound break-in threshold and other speech processing, according to an embodiment of the invention.

FIG. 7 illustrates inbound break-in instances using a dynamic break-in threshold and other speech processing, according to an embodiment of the invention.

FIG. 8 illustrates a speakerphone control operation, according to an embodiment of the invention.

FIGS. 9(A) and 9(B) illustrate processing of inbound and outbound speech in different regards, according to an embodiment of the invention.

FIGS. 10(A) and 10(B) illustrate outbound and inbound path control including an interposed hangtime, according to an embodiment of the invention.

FIG. 11 illustrates a speakerphone control operation, according to an embodiment of the invention.

FIGS. 12(A) and 12(B) illustrate processing of inbound and outbound speech in different regards, according to an embodiment of the invention.

FIG. 13 illustrates speaker path activation, according to conventional far-end processing during noisy conditions.

FIGS. 14(A) and 14(B) illustrate speaker path activation during noisy conditions, according to an embodiment of the invention.

### DETAILED DESCRIPTION OF EMBODIMENTS

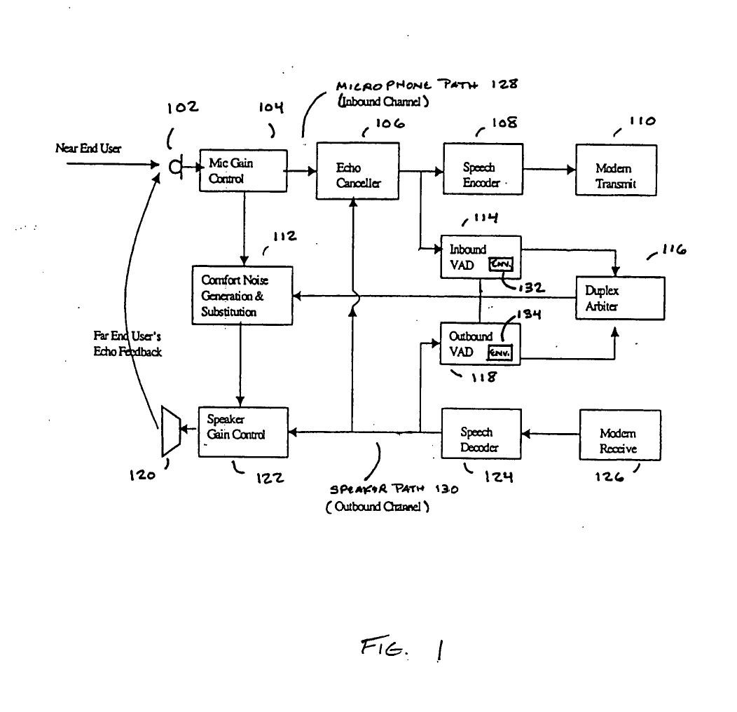

FIG. 1 illustrates an architecture of a communications device having a speakerphone capability according to an embodiment of the invention. The device illustrated in FIG. 1 may be or include, for instance, a cellular telephone handset, a voice-enabled wired or wireless device such as a networked Voice over IP (VoIP) or ISDN telephone device, a two-way radio communications device, a modem or hybrid telephone/modem device, a wired or wireless telephone connected to the public switched telephone network (PSTN) via a speakerphone base, or other communications devices or platforms. In general, according to the illustrated architecture the communications device may include a microphone path 128 which includes a microphone 102 or other acoustical or other input transducer, and a speaker path 130 which includes a speaker 120 or other acoustical or other output transducer. In embodiments, in general only one of the microphone path 128 and the speaker path 130 may be activated at the same time, to avoid feedback between the two transducers. Other modes are possible in other embodiments. The microphone path 128 may from time to time be referred to as the inbound or near-end channel, and the speaker path 130 as the outbound or far-end channel, respectively.

The microphone 102 in the microphone path 128 may be connected to a microphone gain control 104, to boost or attenuate the output of microphone 102 as appropriate. The output of the microphone gain control 104 may be communicated to an echo canceller 106 to remove a portion of any feedback, including echo, leaking from speaker 120 to microphone 102. Echo canceller 106 may for example be implemented in hardware, software, firmware of a combination thereof. Echo canceller 106 may for instance be implemented instance using commercially available parts such as dedicated integrated circuits manufactured by Oki Semiconductor or others, or using software modules such as echo canceller modules available for digital signal processors such as the DSP 56000 family manufactured by Motorola Corp., digital signal processors made by Texas Instruments Inc., or others. In embodiments, the echo canceller 106 may incorporate or implement known echo cancellation algorithms, for instance algorithms related to or incorporated in International Telecommunications Union (ITU) standard G.165 or other cancellation algorithms or techniques. In embodiments, the echo canceller 106 may reduce the echo or other feedback by as much as 35 dB or more, but may typically not eliminate the full degree of feedback present in the signal generated by the microphone 102.

The output of the echo canceller 106 may be communicated to a speech encoder 108, which compresses or otherwise processes speech input for purposes of wireless or other transmission. The speech encoder 108 may be implemented using known speech compression or other algorithms, for instance algorithms related to or incorporated in ITU standards such as ITU G.711, G.723, G.726, G.729, or other protocols. Those standards or protocols may incorporate or implement for example the Low-Delay Code-Excited Linear Prediction (LD-CELP) speech coding algorithm, which encodes 2.5 ms frames of digitized, telephone bandwidth speech or audio signals sampled at 8 KHz, or other digitizing or other techniques. Other speech compression/decompression (codec) algorithms, software or standards may be used. The speech encoder 108 may likewise be implemented in hardware, software, firmware or a combination thereof, including using programmable digital signal processors or other components.

After a user's speech input is encoded by the speech encoder 108, the encoded speech may be communicated to the modem transmit module 110. The modem transmit module 110 may prepare the encoded signal for wireless or other transmission via an antenna or other air or other interface, for instance generating wireless transmission in the 800/900 MHz, 1.9 GHz or other cellular, PCS or other frequency spectra for voice or other communications.

On the receiver side, a modem receiver module 126 may likewise be coupled to a cellular antenna or other source of radio frequency (RF) or other wireless or other energy to capture, downconvert and/or demodulate wireless carrier signals. The modem receive module 126 may communicate the demodulated received signal to a speech decoder 124. The speech decoder 124 may in general perform the reverse type of operation from the speech encoder 108, for example to decompress far-end speech from a remote user of another cellular handset or other device. The output of speech decoder 124 may be communicated to the speaker gain control 122, providing amplification or attenuation of the decoded speech for driving the speaker 120, such as the earpiece speaker in a cellular handset or other transducer. The output of the speech decoder 124 may also be communicated to the echo canceller 106 to perform echo detection and cancellation processing.

In embodiments of the invention such as that illustrated in FIG. 1, the microphone path 128 and the speaker path 130 may each be coupled to further circuitry to monitor and manage the speakerphone operation of the communications device. More specifically, the output of the echo canceller 106 may also be communicated to an inbound voice activity detector (VAD) 114. The output of the speech decoder 124 may similarly be communicated to an outbound voice activity detector (VAD) 118. Each of inbound VAD 114 and outbound VAD 118 may also be implemented using hardware, software, firmware of a combination thereof. The inbound VAD 114 and outbound VAD 118 may, for instance, each be implemented using a microprocessor, a digital signal processor or other processors. The VAD 114 and VAD 118 may each generate a speech energy envelope, speech sample, voice-present or other types of speech detection signals or functions used to identify the presence of speech information, as opposed to background or other types of noise. Inbound VAD 114 and outbound VAD 118 may for instance be programmed to perform speech detection algorithms, such as those related to or incorporated in ITU standards or others, for instance according or related to the ITU G.711, G.723, G.726, G.729 or other standards. The inbound VAD 114 and outbound VAD 118 may also be coupled together, to permit direct communication therebetween.

The output of each of the inbound VAD 114 and the outbound VAD 118 may in turn be communicated to a duplex arbiter 116. Duplex arbiter 116 may also be implemented using hardware such as a microprocessor or digital signal processor, in software, firmware or a combination thereof to perform supervisory tasks to arbitrate and manage the activation of the microphone path 128, speaker path 130 and other resources to enhance speakerphone and other operation. The duplex arbiter 116 may, for instance, determine instances in time when the inbound (near-end, or handheld user of the communications device) speech energy is significant while the outbound (far-end, or remote user) speech energy is negligible so that the duplex arbiter 116 may activate the microphone path 128 to capture that local speech, while deactivating or muting the speaker path 130 since the far-end user is interpreted as not speaking or communicating.

Conversely, in instances when the inbound speech energy detected by the inbound VAD 114 is negligible while the outbound speech energy detected by the outbound VAD 118 is significant, the duplex arbiter 116 may activate the speaker path 130 while deactivating the microphone path 128, so that the far-end user's speech may be heard over the speaker 120.

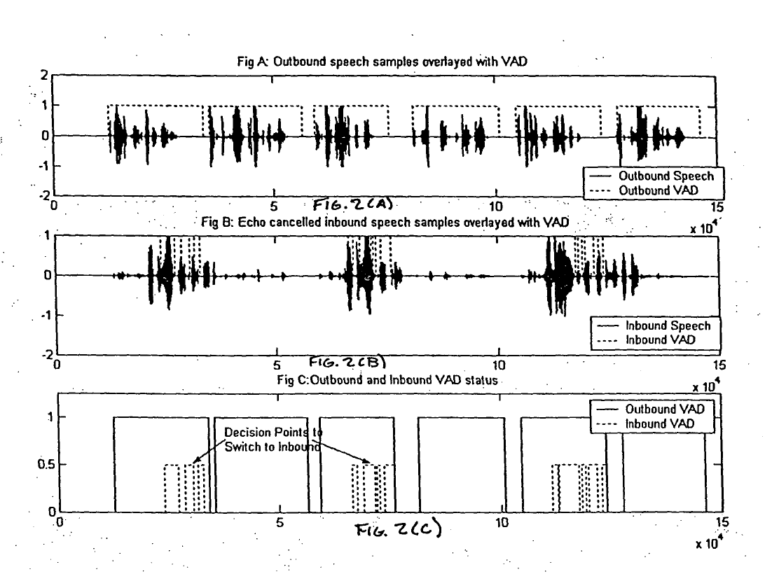

On the other hand, during those intervals of time in which both the inbound VAD 114 and outbound VAD 118 detect significant speech energy in their respective paths, the duplex arbiter 116 may apply selective criteria to decide which path to activate. As illustrated for instance in FIGS. 2(A)-2(C), intervals may occur when both the inbound VAD 114 (FIG. 2(B)) and outbound VAD 118 (FIG. 2(A)) have detected speech energy greater than their respective detection thresholds, and present duplex arbiter 116 with a speech-detected signal, illustrated as a gate function.

As illustrated in FIG. 2(C), when both VAD signals are active, the duplex arbiter 116 may choose to activate one or the other path. As illustrated in that figure, in embodiments the duplex arbiter 116 may switch control to the microphone path 128 (inbound channel) when speech is recognized at the microphone 102, even when the absolute value of the energy presented by the presumed speech signal is less than the output of the outbound VAD 118. This decision criteria may be applied because the energy of the speech content in the microphone path 128 may typically be significantly less than that of the speaker path 130, even when a user is speaking with a normal voice close to the microphone 102, which intensity only decreases when the cellular handset or other device is placed farther away from the user.

Operation of this type may permit seamless transitions between the near-end and far-end user's speech in conversation, and prevent artifacts such as channel lockouts. In embodiments, as illustrated the duplex arbiter 116 may also communicate with a comfort noise generation and substitution module 112, likewise capable of being implemented in hardware, software or firmware or a combination thereof. The comfort noise generation and substitution module 112 may in turn also communicate with the microphone gain control 104 and the speaker gain control 122, to output white noise or other comparatively pleasant or innocuous sounds during path transitions, dead spots such as when both the microphone path 128 and speaker path 130 may be muted, or at other times. In other embodiments or under other conditions, the duplex arbiter 116 may award control to the microphone path 128 or the speaker path 130 under different fixed or dynamic criteria used for decision processing.

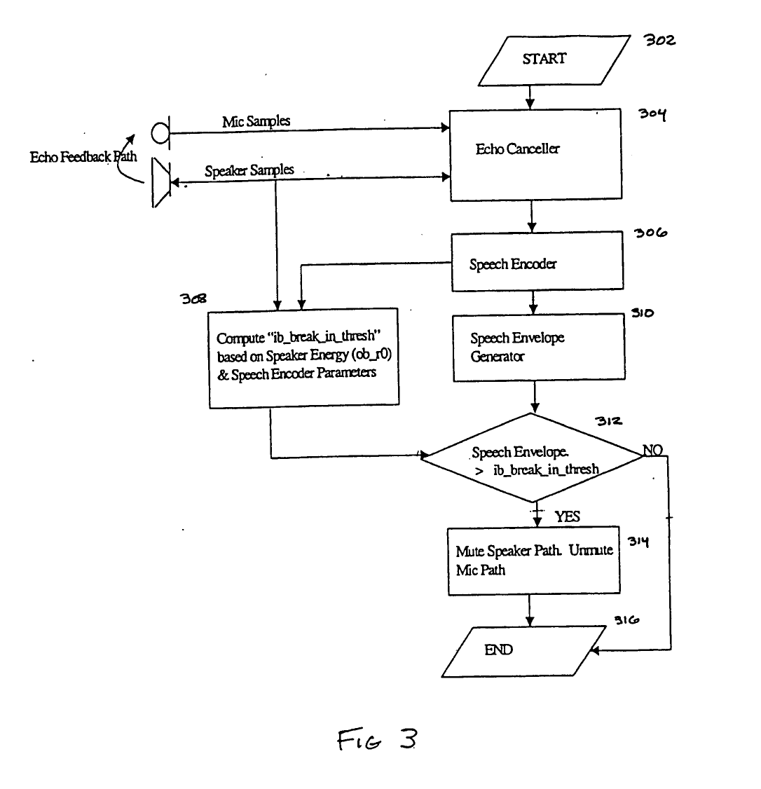

In an embodiment illustrated in FIG. 3, for example, a threshold used to award control to the microphone path 128 may be dynamically computed based on the energy being produced by speech encoder and other parameters. In step 302, processing may begin. In step 304, microphone samples from the microphone 102 and speaker samples from the speaker 120 may be communicated to the echo canceller 106. In step 306, the speech encoder 108 may process the output of echo canceller 106. In step 308, a break-in threshold, referred to as “ib_break_in_thresh” and used for deciding to award control to the microphone path 128 while muting the speaker path 130, may be dynamically computed based on the outbound speech (or speaker) energy for the present discrete speech frame (n) and speech encoder parameters. In embodiments, that calculation may be or include the following computations:

Algorithm 1

```
ib_break_in_thresh(n) = β*ob_r0(n);
    IF (ib_break_in_thresh(n) > ib_break_in_thresh(n−1))
        ib_break_in_thresh(n) = β*ob_r0(n);
    ELSE
        ib_break_in_thresh(n) = α*ib_break_in_thresh(n−1) +
(1−α)*β*ob_r0(n);
    END
Where:
ob_r0(n) = outbound speech energy for a frame n;
n = current speech frame
β = an energy scalar; and
α = decay rate.
```

In step 310, the output of the speech encoder 108 may also be communicated to an inbound speech envelope generator 132, which may in embodiments be integrated with or interface to inbound VAD 114. Inbound speech envelope generator 132 may generate a moving envelope representing speech energy, such as a moving average or other representation of speech energy of the signal in the microphone path 128. Outbound speech envelope generator 134, which also may be integrated with or interface to outbound VAD 118, may similarly generate an envelope output based on the signal in the speaker path 130.

In step 312, the resulting speech envelope may be compared to the current inbound break-in threshold (ib_break_in_thresh). If the envelope of the inbound speech exceeds that threshold, processing proceeds to step 314 where the duplex arbiter 116 may mute the speaker path 130 and activate or unmute the microphone path 128, thus allowing the near-end user's speech to be captured and communicated to the far-end user. If the envelope of the inbound speech does not exceed the inbound break-in threshold (ib_break_in_thresh), processing proceeds to step 316 where processing for the current frame of time may end, following which processing may repeat, proceed to other tasks or end.

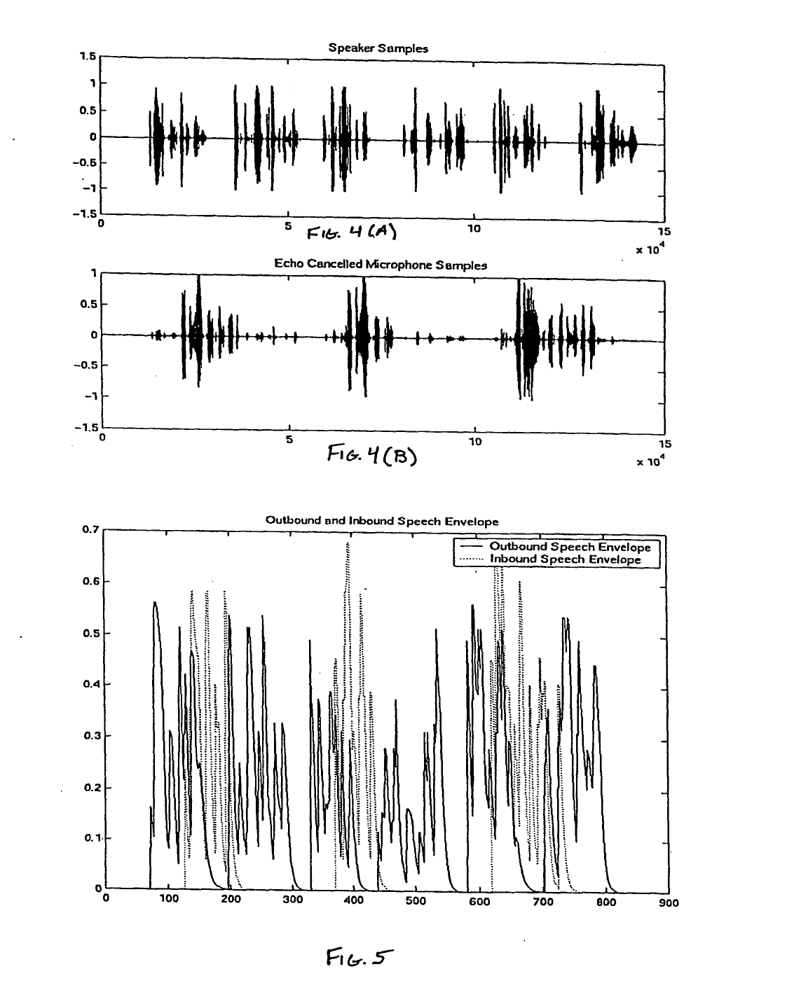

FIGS. 4(A) and 4(B) illustrate speaker samples and echo-cancelled microphone samples, respectively, generated according to the embodiment illustrated in FIG. 3. FIG. 5 depicts an illustrative speech envelope for the inbound and outbound signals generated according to that embodiment. As illustrated in that figure, at certain times the inbound signal may exceed the outbound signal, while at other times the outbound signal may be greater than the inbound signal.

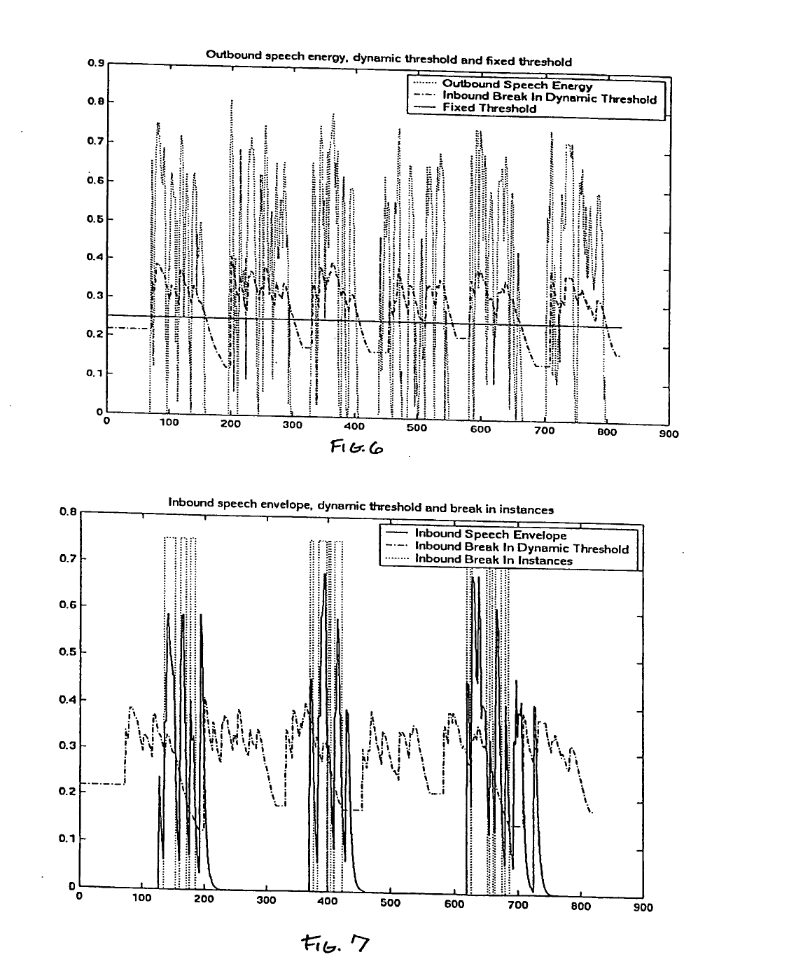

FIG. 6 illustrates an overlay of the outbound (speaker path 130) speech energy on an illustrative inbound dynamic break-in threshold, with a fixed inbound break-in threshold also shown for comparison. As illustrated in that figure, the inbound break-in threshold may be made a dynamic function of the parameters of Algorithm 1 or otherwise, resulting in a time-varying threshold which tracks, at least in part, the outbound speech energy with which the inbound speech is in competition. Thus, in intervals during which the outbound speech energy is comparatively high, the inbound break-in threshold rises to a relatively higher plateau, forcing near-end speech at the microphone 102 to be greater in intensity to capture the channel. Conversely, the inbound break-in threshold may be relaxed in intervals during which the outbound speech energy decreases, so that comparatively softer near-end speech may activate the microphone path 128, unlike the fixed threshold approach.

FIG. 7 illustrates the inbound speech envelope, inbound break-in dynamic threshold and inbound break-in instances generated according to the embodiment shown in FIG. 3. As illustrated in that figure, the inbound break-in instances may consequently occur in those periods of time where a relatively quiet outbound channel has driven the inbound break-in threshold to a lower level, enabling the microphone path 128 to appropriately seize the channel even with less energetic speech.

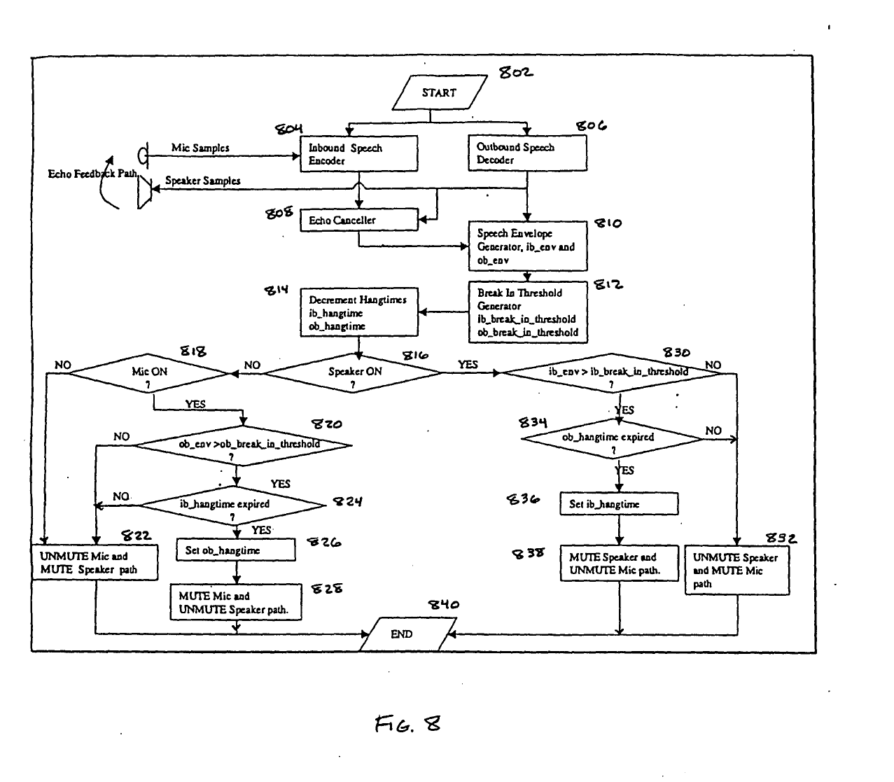

When encoded speech is choppy or contains large swings in amplitude or other artifacts, in cases those inputs may cause rapid switching between microphone path 128 and speaker path 130, or other “race” or other undesirable conditions. In an embodiment of the invention illustrated in FIG. 8, the duplex arbiter 116 and other cooperating components may insert a delay interval or hangtime before permitting a transition of control from the microphone path 128 to the speaker path 130, and vice versa. The introduction of a hangtime may serve to prevent such race conditions when one or both of the near-end and far-end speech contains rapidly varying amplitudes.

As shown in FIG. 8, in step 802 processing may begin. In step 804, near-end samples from the microphone 102 may be processed by the speech encoder 108. In step 806, outbound speech from the far-end user may be processed by speech decoder 124. In step 808, the echo canceller 106 may receive the outputs of the speech encoder 108 and the speech decoder 124 to suppress echo and other feedback artifacts. In step 810, the echo-cancelled inbound speech and the decoded outbound speech may be communicated to inbound speech envelope generator 132 and outbound speech envelope generator 134, respectively, to generate speech energy envelopes or other functions.

In step 812, an inbound break-in threshold (ib_break_in_threshold) and outbound break-in threshold (ob_break_in_threshold) may be generated, for instance according to the embodiment illustrated in FIG. 3 or otherwise. In step 814, at least one of an inbound hangtime (ib_hang_time) and an outbound hangtime (ob_hang_time) may be decremented, or set to initial values if the communications device is in an initialization mode such as in a startup or reset operation. In step 816, a determination may be made whether the speaker path 130 is activated. If the speaker path 130 is not activated, processing may proceed to step 818 where a determination may be made whether the microphone path 128 is activated.

If the microphone path 128 is not activated, processing may proceed to step 822 where the microphone path 128 may be activated or unmuted, while the speaker path 130 may be deactivated or muted. After step 822, control may proceed to step 840 where processing for the current frame may end, following which processing may repeat, proceed to other tasks or end.

If the determination at step 818 is that the microphone path 128 is on, processing may proceed to step 820 where a determination may be made the outbound speech envelope (ob_env) may be greater than the outbound break-in threshold (ob_break_in_threshold). If the outbound speech envelope (ob_env) is greater than the outbound break-in threshold (ob_break_in_threshold), processing may proceed to step 824 where a determination may be made whether the inbound hangtime (ib_hang_time) has expired. If the inbound hangtime (ib_hang_time) has not expired, processing may proceed to step 822 where again the microphone path 128 may be activated or unmuted, while the speaker path 130 may be deactivated or muted.

If at step 824 the inbound hangtime (ib_hangtime) has expired, processing may proceed to step 826 where an outbound hangtime (ob_hangtime) may be set to begin a hangtime period for the speaker path 130. The outbound hangtime (ob_hangtime) may for instance be set to a fixed amount of time, such as 4 seconds or another value according to implementation. In embodiments, the outbound hangtime may be computed or set on a dynamic basis, for instance as a function of prior inbound or outbound hangtimes, detected speech energy in the inbound or outbound paths or other variables. In step 828, the microphone path 128 may be deactivated or muted, while the speaker path 130 may be activated or unmuted, after which control may proceed to step 840 where processing for the current frame of time may end, following which processing may repeat, proceed to other tasks or end.

If at step 820 the outbound speech envelope (ob_env) is determined to not exceed the outbound break-in threshold (ob_break_in_threshold), processing may proceed to step 822 where again the microphone path 128 may be activated or unmuted, while the speaker path 130 may be deactivated or muted. Control may then also proceed to step 840 where processing for the current frame of time may end, following which processing may repeat, proceed to other tasks or end.

If at step 816 a determination is made that the speaker path 130 is on, processing may proceed to step 830 in which a determination may be made whether the inbound envelope (ib_envelope) exceeds the inbound break-in threshold (ib_break_in_threshold). If the inbound envelope (ib_envelope) does not exceed the inbound break-in threshold (ib_break_in_threshold), processing may proceed to step 832 where the speaker path 130 may be activated or unmuted while the microphone path 128 may be deactivated or muted. Following that step, control may then proceed to step 840 where processing for the current frame of time may end, following which processing may repeat, proceed to other tasks or end.

If at step 830 a determination is made that the inbound envelope (ib_envelope) exceeds the inbound break-in threshold (ib_break_in_threshold), processing may proceed to step 834 where a determination may be made whether the outbound hangtime (ob_hangtime) has expired. If the outbound hangtime (ob_hangtime) has not expired, processing may likewise proceed to step 832 where the speaker path 130 may be activated or unmuted while the microphone path 128 may be deactivated or muted.

If at step 834 a determination is made that the outbound hangtime (ob_hangtime) has expired, processing may proceed to step 836 where the inbound hangtime may be set to a fixed amount of time, such as 4 seconds or another value according to implementation. In embodiments, the inbound hangtime may be computed or set on a dynamic basis, for instance as a function of prior inbound or outbound hangtimes, detected speech energy in the inbound or outbound paths or other variables. Processing may then proceed to step 838, where the speaker path 130 may be deactivated or muted while the microphone path 128 may be activated or unmuted. Following that step, control may then proceed to step 840 where processing for the current frame of time may end, following which processing may repeat, proceed to other tasks or end.

In the embodiment of the invention illustrated in FIG. 8, the awarding of control to the microphone path 128 or the speaker path 130 may therefore depend on more than one criterion. Those criteria may include the exceeding of speech envelope thresholds but also interposing a hangtime during which the currently active path may retain control, regardless of the activity in the other path. The inbound and outbound hangtimes may in embodiments be fixed or dynamic, and may be incremented or decremented depending on conditions. For instance, during periods of increasing noise or other parameters, either or both of the hangtimes may be incremented, or during periods of decreasing noise or other parameters, either or both of the hangtimes may be decremented. Greater continuity in speech or other interaction may therefore be achieved.

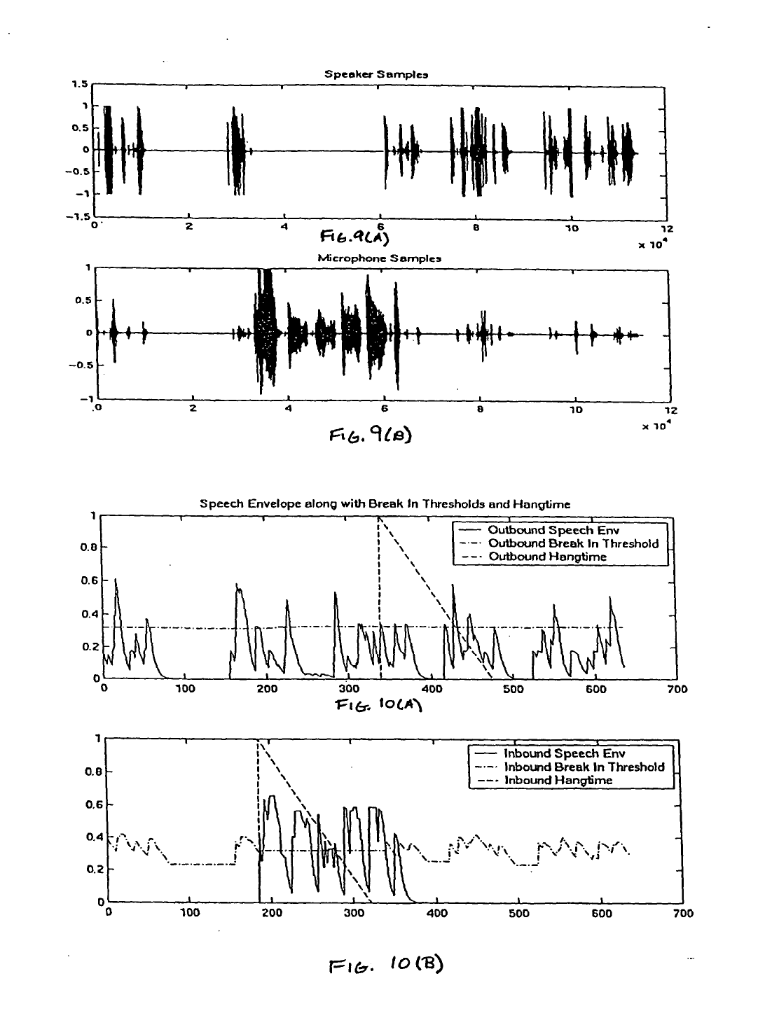

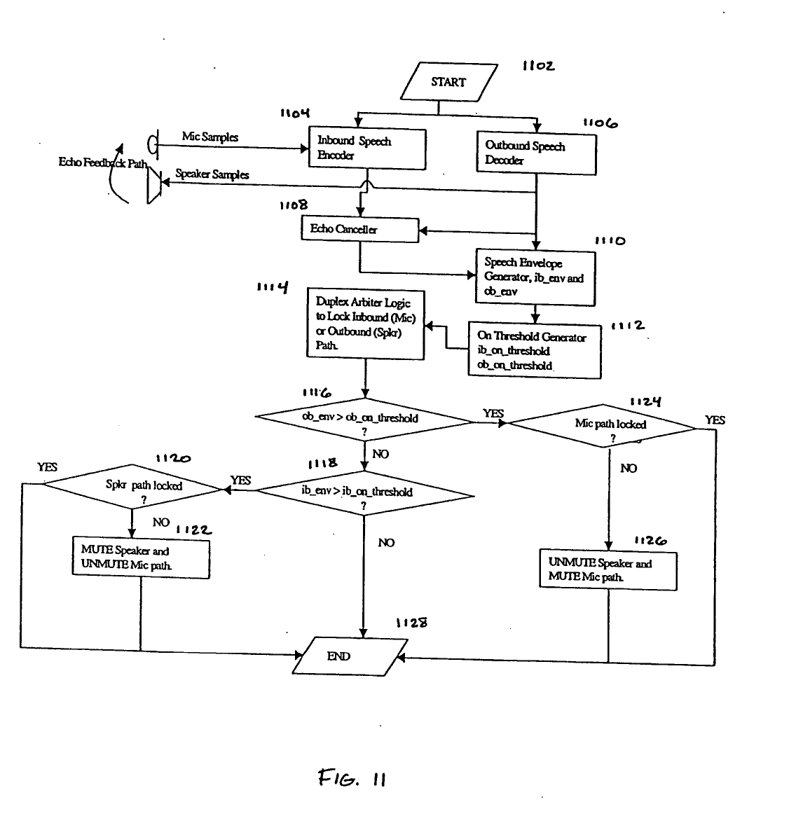

FIG. 9(A) illustrates speech samples from speaker 120 and FIG. 9(B) illustrates speech samples from microphone 102 which may be processed in one regard according to the embodiment illustrated in FIG. 8. FIG. 10(A) illustrates the resulting outbound speech envelope (ob_env) along with the outbound break-in threshold (ob_break_in_thershold).

FIG. 10(A) also illustrates the application of an outbound hangtime (ob_hangtime) interval during which the speaker path 130 may retain control and continue to be activated, despite the presence of energetic speech in the microphone path 128. Conversely, FIG. 10(B) illustrates the inbound speech envelope (ib_env) along with the inbound break-in threshold (ib_break_in_thershold). FIG. 10(B) also illustrates the application of an inbound hangtime (ib_hangtime) interval during which the microphone path 128 may retain control and continue to be activated, despite the presence of energetic speech in the speaker path 130. The introduction of these delay intervals may increase the sense of continuity for the near-end and far-end users during speakerphone operation.

In particularly noisy environments, such as for example in urban areas, when an automobile window may be open, during playback of a noisy voice message or at other times, the fricatives and other signal components may tend to trigger the speaker path 130 to be muted, even when still-intelligible speech is present. This may in one regard be due to the crossing of an outbound muting threshold ordinarily intended to switch the speaker path 130 off when the far-end user input has degraded into noise. In an embodiment of the invention illustrated in FIG. 11, this effect may be addressed in one regard by eliminating the outbound off threshold (ob_off_threshold) and permitting the speaker path 130 to occupy the channel until the microphone path 128 contains energetic speech, rather than configuring the speaker path 130 to switch itself off below that threshold.

As shown in that figure, processing may begin in step 1102. In step 1104, near-end samples from the microphone 102 may be processed by the speech encoder 108. In step 1106, outbound speech from the far-end user may be processed by speech decoder 124. In step 1108, the echo canceller 106 may receive the outputs of the speech encoder 108 and the speech decoder 124 to suppress echo and other feedback artifacts. In step 1110, the echo-cancelled inbound speech and the decoded outbound speech may be communicated to inbound speech envelope generator 132 and outbound speech envelope generator 134, respectively, to generate speech energy envelopes or other functions.

In step 1112, an inbound on threshold (ib_on_threshold) and outbound on threshold (ob_on_threshold) may be generated, for instance similarly to the embodiment illustrated in FIG. 3 or otherwise. In step 1114, the duplex arbiter 1116 may apply control logic to lock to the microphone path 128 or the speaker path 130, according to the current speech envelopes of the paths.

In step 1116, a determination may be made whether the outbound envelope (ob_env) exceeds the outbound on threshold (ob_on_threshold). If the outbound envelope (ob_env) does not exceed the outbound on threshold (ob_on_threshold), processing may proceed to step 1118 where a determination may be made whether the inbound envelope (ib_env) exceeds the inbound on threshold (ib_on_threshold). If the inbound envelope (ib_env) exceeds the inbound on threshold, processing may proceed to step 1120 where a determination may be made whether the speaker path 130 is locked, that is, currently has control of the communications channel, such as a wireless cellular or other connection. If the speaker path 130 is locked, the state of the microphone path 128 and speaker path 130 may remain unchanged from the start of processing at step 1102 and control may proceed to step 1128 where processing for the current frame may end, following which processing may repeat, proceed to other tasks or end.

If the determination at step 1120 is that the speaker path 130 is not locked, processing may proceed to step 1122 where the speaker path 130 may be deactivated or muted, while the microphone path 128 may be activated or unmuted. Processing then may likewise proceed to step 1128 to repeat, proceed to other tasks or end.

If the determination at step 1118 is that the inbound envelope (ib_env) does not exceed the inbound on threshold (ib_on_threshold), processing may proceed to step 1128 to repeat, proceed to other tasks or end.

If the determination at step 1116 is that the outbound envelope (ob_env) exceeds the outbound on threshold (ob_on_threshold), processing may proceed to step 1124 where a determination may be made whether the microphone path 128 is locked. If the microphone path 128 is not locked, control may proceed to step 1126 where the speaker path 130 may be activated or unmuted while the microphone path 128 may be deactivated or muted. Processing then may proceed to step 1128 to repeat, proceed to other tasks or end. Likewise, if the determination at step 1124 is that the microphone path 128 is locked, the state of the microphone path 128 and speaker path 130 may remain unchanged from the start of processing at step 1102, and control may proceed to step 1128 to repeat, proceed to other tasks or end.

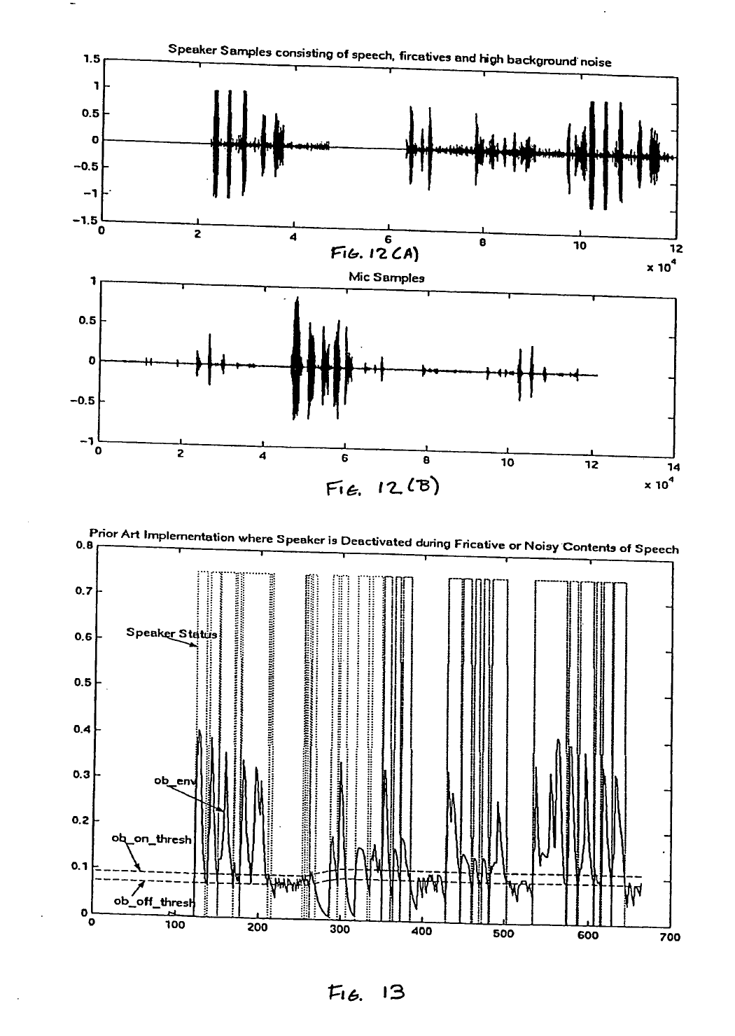

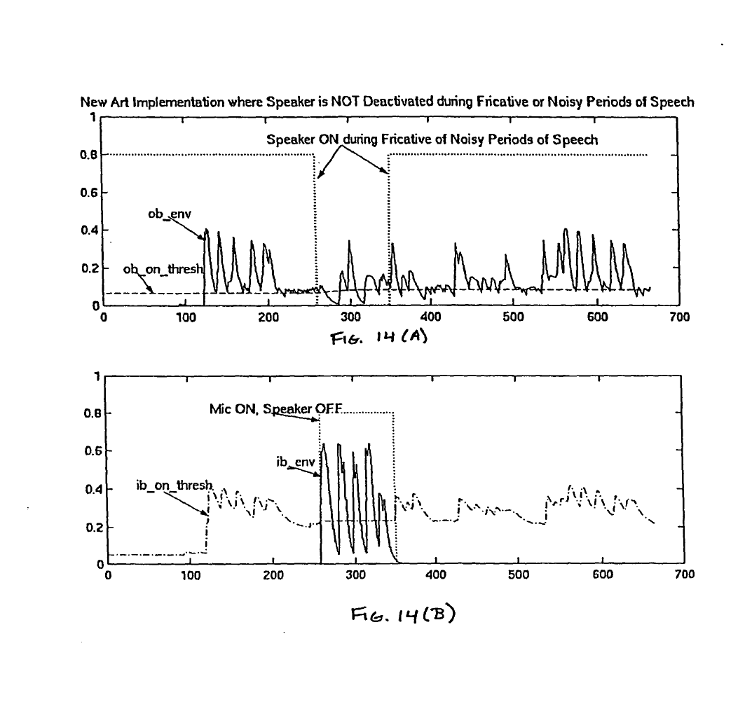

FIG. 12(A) illustrates samples from speaker 120 containing fricatives and other noise components, and FIG. 12(B) illustrates samples from microphone 102 at the same time which may together be processed for instance according to the embodiment illustrated in FIG. 11. FIG. 13 illustrates speakerphone control which might occur when operating upon such signals without the benefit of the invention, including rapid switching of the speaker path 130 between on and off states, due to the fricative and other noise artifacts.

FIG. 14(A) on the other hand illustrates the resulting speakerphone operation according to the embodiment of the invention illustrated in FIG. 11, in which the speaker path 130 maintains control of the channel even during relatively noisy background periods, in part because the outbound off threshold is eliminated, allowing the speaker path 130 to remain active. Instead of choppy or punctuated switching, the speaker path remains activated until the microphone path 128 appropriately seizes control of the channel due to energetic speech exceeding the inbound on threshold, as illustrated in FIG. 14(B). Smoother more continuous conversation results.

The foregoing description of the system and method for speakerphone operation according to the invention is illustrative, and variations in configuration and implementation will occur to persons skilled in the art. For instance, while the invention has generally been described as containing discrete voice detectors in the form of inbound VAD 114 and outbound VAD 118, in embodiments the functions or parts of the functions of the two voice activity detectors could be combined in one part, or in one software module. More than two paths could also be managed according to the invention. Similarly, while the invention has been described with respect to an inbound path including an echo canceller 106, in embodiments other types of noise suppressors could be implemented, or in embodiments that component could be omitted or modified.

It has likewise been noted that the communications device in which the invention may operate may be or include a cellular telephone, but could consist of other communications platforms such as wired or wireless telephones, two-way radios, base stations for wireless telephones, network-enabled wireless communications devices such as 802.11a, 802.11b, 802.11g or other short or long-range telephony or other units, or other equipment as well.

Yet further, while the invention has generally been described in terms of a speakerphone architecture in which the electronic intelligence governing the speakerphone operation is integral with the cellular telephone or other communications device, in other embodiments the intelligence may be embedded or shared in an attachment coupled to the communications device. For instance, the intelligence may be embedded or shared in a detachable battery, a headphone device, a tabletop or other fixed or non-wearable speakerphone unit, or in other accessories or parts. For example, the intelligence may enable a speakerphone operation through a car audio system coupled to a cellular telephone.

In the case of a detachable or coupleable unit which adds or enhances speakerphone capability in a communications device, the intelligence embedded in the add-on device may communicate with the electronics of the communications device through interfaces such as a serial port such as an RS-232, a universal serial bus (USB) or a universal asynchronous receiver/transmitter (UART) connection, an infrared data (IrDA) port, a radio frequency link, or other serial, parallel or other data ports or other connections. The scope of the invention is accordingly intended to be limited only by the following claims.

1. A system for managing speakerphone operation in a communications device, comprising:
a first voice activity detector, configured to communicate with an inbound path of the communications device, the first voice activity detector generating at least first voice data based upon a signal in the inbound path;
a second voice activity detector, configured to communicate with an outbound path of the communications device, the second voice activity detector generating at least second voice data based upon a signal in the outbound path; and
a processor, communicating with the first voice activity detector and the second voice activity detector, the processor controlling at least one of the inbound path and the outbound path based upon at least one of the first voice data and the second voice data.

2. A system according to claim 1, wherein the inbound path is coupled to an input transducer.

3. A system according to claim 2, wherein the input transducer comprises a microphone.

4. A system according to claim 1, wherein the outbound path is coupled to an output transducer.

5. A system according to claim 4, wherein the output transducer comprises a speaker.

6. A system according to claim 1, wherein the communications device comprises at least one of a cellular telephone, a voice-enabled network device, and a telephone device.

7. A system according to claim 1, wherein the first voice data comprises at least one of a first voice energy signal, a first voice envelope, a first voice sample, and a first voice present signal.

8. A system according to claim 1, wherein the second voice data comprises at least one of a second voice energy signal, a second voice envelope, a second voice sample and a second voice present signal.

9. A system according to claim 1, wherein the controlling performed by the processor comprises awarding control of a communications channel to one of the inbound path and the outbound path based upon a comparison of the first voice data and the second voice data.

10. A system according to claim 9, wherein the communications channel comprises a wireless communications channel.

11. A system according to claim 1, wherein the signal in the inbound path comprises at least a voice signal of a local user.

12. A system according to claim 1, wherein the signal in the outbound path comprises at least a voice signal of a remote user.

13. A system according to claim 1, further comprising a comfort noise generator, the processor communicating with the comfort noise generator to generate comfort noise at selected times based on at least one of the first voice data and the second voice data.

14. A system according to claim 1, further comprising an echo canceller, the echo canceller being coupled to the inbound path to cancel at least a portion of the signal in the outbound path.

15. A system according to claim 1, wherein the inbound channel further comprises a speech encoder module.

16. A system according to claim 1, wherein the outbound channel further comprises a speech decoder module.

17. A system according to claim 1, further comprising an interface to a modem transmitter module.

18. A system according to claim 1, further comprising an interface to a modem receiver module.

19. A method for managing speakerphone operation in a communications device, comprising:
generating at least first voice data based upon a signal in an inbound path of the communications device;
generating at least second voice data based upon a signal in an outbound path of the communications device; and
controlling at least one of the inbound path and the outbound path based upon at least one of the first voice data and the second voice data.

20. A method according to claim 19, wherein the inbound path is coupled to an input transducer.

21. A method according to claim 20, wherein the input transducer comprises a microphone.

22. A method according to claim 19, wherein the outbound path is coupled to an output transducer.

23. A method according to claim 22, wherein the output transducer comprises a speaker.

24. A method according to claim 19, wherein the communications device comprises at least one of a cellular telephone, a voice-enabled network device, and a telephone device.

25. A method according to claim 19, wherein the first voice data comprises at least one of a first voice energy signal, a first voice envelope, a first voice sample, and a first voice present signal.

26. A method according to claim 19, wherein the second voice data comprises at least one at least one of a second voice energy signal, a second voice envelope, a second voice sample, and a second voice present signal.

27. A method according to claim 19, wherein the step of controlling comprises awarding control of a communications channel to one of the inbound path and the outbound path based upon a comparison of the first voice data and the second voice data.

28. A method according to claim 27, wherein the communications channel comprises a wireless communications channel.

29. A method according to claim 19, wherein the signal in the inbound path comprises at least a voice signal of a local user.

30. A method according to claim 19, wherein the signal in the outbound path comprises at least a voice signal of a remote user.

31. A method according to claim 19, further comprising generating comfort noise at selected times based on at least one of the first voice data and the second voice data.

32. A method according to claim 19, further comprising canceling at least a portion of the signal in the outbound path from the inbound path.

33. A method according to claim 19, wherein the inbound channel further comprises a speech encoder module.

34. A method according to claim 19, wherein the outbound channel further comprises a speech decoder module.

35. A method according to claim 19, wherein the communications device further comprises a modem transmitter module.

36. A method according to claim 19, wherein the communications device further comprises a modem receiver module.

37. A system for managing speakerphone operation in a communications device, comprising:
first executable code, the first executable code generating at least first voice data based upon a signal in an inbound path of the communications device;
second executable code, the second executable code generating at least second voice data based upon a signal in an outbound path of the communications device; and
third executable code, the third executable code controlling at least one of the inbound path and the outbound path based upon at least one of the first voice data and the second voice data.

38. A communications system, comprising:
a communications device, the communications device comprising
a first voice activity detector, communicating with an inbound path, the first voice activity detector generating at least first voice data based upon a signal in the inbound path,
a second voice activity detector, communicating with an outbound path, the second voice activity detector generating at least second voice data based upon a signal in the outbound path, and
a processor, communicating with the first voice activity detector and the second voice activity detector, the processor controlling at least one of the inbound path and the outbound path based upon at least one of the first voice data and the second voice data;
a transceiver; and
a wireless channel, coupled to the transceiver, the wireless channel configured to communicate with the inbound path and the outbound path of the communications device.

39. A system for managing speakerphone operation in a communications device, comprising:
voice activity detection means, communicating with each of an inbound path and an outbound path each of the communications device, the voice activity detection means generating at least first voice data based upon a signal in the inbound path and at least second voice data based upon a signal in the outbound path; and
processing means, configured to communicate with the voice activity detection means, the processing means controlling at least one of the inbound path and the outbound path based upon at least one of the first voice data and the second voice data.

40. A system for managing speakerphone operation in a communications device, comprising:
executable voice activity detection code, receiving input from each of an inbound path and an outbound path each of the communications device, the executable voice activity detection code generating at least first voice data based upon a signal in the inbound path and at least second voice data based upon a signal in the outbound path; and
a processor, configured to interface with the executable voice activity detection code, the processor controlling at least one of the inbound path and the outbound path based upon at least one of the first voice data and the second voice data.

41. A system for managing speakerphone operation in a communications device, comprising:
a processor, the processor being configured to execute
voice activity detection code, receiving input from each of an inbound path and an outbound path each of the communications device, the executable voice activity detection code generating at least first voice data based upon a signal in the inbound path and at least second voice data based upon a signal in the outbound path, and
arbitration code, the arbitration code controlling at least one of the inbound path and the outbound path based upon at least one of the first voice data and the second voice data.

42. A system for managing speakerphone operation in a communications device, comprising:
a first voice activity detector, configured to communicate with an inbound path of the communications device, the first voice activity detector generating at least a first voice detection signal based upon at least a first voice threshold applied to a signal in the inbound path;
a second voice activity detector, configured to communicate with an outbound path of the communications device, the second voice activity detector generating at least a second voice detection signal based upon at least a second voice threshold applied to a signal in the outbound path; and
a processor, communicating with the first voice activity detector and the second voice activity detector, the processor controlling at least one of the inbound path and the outbound path based upon at least a comparison of the first voice detection signal and the second voice detection signal.

43. A system according to claim 42, wherein the first voice detection signal comprises an assertable first voice present signal and the second voice detection signal comprises an assertable second voice present signal.

44. A system according to claim 43, wherein the comparison comprises testing for the assertion of the first voice present signal and the second voice present signal.

45. A system according to claim 44, wherein the processor awards control of a communications channel to the inbound path when the first voice present signal is asserted and the second voice present signal is not asserted.

46. A system according to claim 44, wherein the processor awards control of a communications channel to the outbound path when the first voice present signal is not asserted and the second voice present signal is asserted.

47. A system according to claim 44, wherein the processor awards control of a communications channel to the inbound path when the first voice present signal is asserted and the second voice present signal is asserted.

48. A system according to claim 44, wherein the processor awards control of a communications channel to the outbound path when the first voice present signal is asserted and the second voice present signal is asserted.

49. A system according to claim 42, wherein the processor adjusts at least the first voice threshold based upon the comparison of the first voice detection signal and the second voice detection signal.

50. A system according to claim 49, wherein the processor adjusts the first voice threshold in dependence upon the second voice detection signal.

51. A system according to claim 50, wherein the processor multiplies the second voice detection signal by a scale factor to adjust the first voice threshold.

52. A system according to claim 42, wherein the processor initiates at least one of the first voice threshold and the second voice threshold based upon a predetermined computation.

53. A system according to claim 42, wherein the inbound path is coupled to an input transducer.

54. A system according to claim 53, wherein the input transducer comprises a microphone.

55. A system according to claim 42, wherein the outbound path is coupled to an output transducer.

56. A system according to claim 55, wherein the output transducer comprises a speaker.

57. A system according to claim 42, wherein the communications device comprises at least one of a cellular telephone, a voice-enabled network device, and a telephone device.

58. A system according to claim 43, wherein the assertable first voice present signal is generated by comparing at least one of a first voice signal energy and a first voice signal envelope to the first voice threshold.

59. A system according to claim 43, wherein the assertable second voice present signal is generated by comparing at least one of a second voice signal energy and a second voice signal envelope to the second voice threshold.

60. A system according to claim 42, wherein the signal in the inbound path comprises at least a voice signal of a local user.

61. A system according to claim 42, wherein the signal in the outbound path comprises at least a voice signal of a remote user.

62. A system according to claim 42, further comprising a comfort noise generator, the processor communicating with the comfort noise generator to generate comfort noise at selected times based on at least one of the first voice detection signal and the second voice detection signal.

63. A system according to claim 42, further comprising an echo canceller, the echo canceller being coupled to the inbound path to cancel at least a portion of the signal in the outbound path.

64. A system according to claim 42, wherein the inbound channel further comprises a speech encoder module.

65. A system according to claim 42, wherein the outbound channel further comprises a speech decoder module.

66. A system according to claim 42, further comprising an interface to a modem transmitter module.

67. A system according to claim 42, further comprising an interface to a modem receiver module.

68. A system for managing speakerphone operation in a communications device, comprising:
first executable code, configured to receive input from an inbound path of the communications device, the first executable code generating at least a first voice detection signal based upon at least a first voice threshold applied to a signal in the inbound path;
second executable code, configured to receive input from an outbound path of the communications device, the second executable code generating at least a second voice detection signal based upon at least a second voice threshold applied to a signal in the outbound path; and
third executable code, the third executable code controlling at least one of the inbound path and the outbound path based upon at least a comparison of the first voice detection signal and the second voice detection signal.

69. A communications system, comprising:
a communications device, the communications device comprising
a first voice activity detector, configured to communicate with an inbound path, the first voice activity detector generating at least a first voice detection signal based upon at least a first voice threshold applied to a signal in the inbound path,
a second voice activity detector, configured to communicate with an outbound path, the second voice activity detector generating at least a second voice detection signal based upon at least a second voice threshold applied to a signal in the outbound path, and
a processor, communicating with the first voice activity detector and the second voice activity detector, the processor controlling at least one of the inbound path and the outbound path based upon at least a comparison of the first voice detection signal and the second voice detection signal;
a transceiver; and
a wireless channel, coupled to the transceiver, the wireless channel configured to communicate with the inbound path and the outbound path of the communications device.

70. A system for managing speakerphone operation in a communications device, comprising:
voice activity detection means, communicating with each of an inbound path and an outbound path each of the communications device, the voice activity detection means generating at least a first voice detection signal based at least upon a first voice threshold applied to a signal in the inbound path and at least a second voice detection signal based at least upon a second voice threshold applied to a signal in the outbound path; and
processing means, configured to communicate with the voice activity detection means, the processing means controlling at least one of the inbound path and the outbound path based upon at least one of the first voice detection signal and the second voice detection signal.

71. A system for managing speakerphone operation in a communications device, comprising:
executable voice activity detection code, receiving input from each of an inbound path and an outbound path each of the communications device, the executable voice activity detection code generating at least a first voice detection signal based upon at least a first voice threshold applied to a signal in the inbound path and at least a second voice detection signal based upon at least a second voice threshold applied to a signal in the outbound path; and
a processor, configured to interface with the executable voice activity detection code, the processor controlling at least one of the inbound path and the outbound path based upon at least one of the first voice detection signal and the second voice detection signal.

72. A system for managing speakerphone operation in a communications device, comprising:
a processor, the processor being configured to execute
voice activity detection code, receiving input from each of an inbound path and an outbound path each of the communications device, the executable voice activity detection code generating at least a first voice detection signal based upon a first voice threshold applied to a signal in the inbound path and at least a second voice detection signal based upon at least a second voice threshold applied to a signal in the outbound path, and
arbitration code, the arbitration code controlling at least one of the inbound path and the outbound path based upon at least one of the first voice detection signal and the second voice detection signal.

73. A system for managing speakerphone operation in a communications device, comprising:
a first voice activity detector, configured to communicate with an inbound path of the communications device, the first voice activity detector generating at least a first voice detection signal based upon a signal in the inbound path;
a second voice activity detector, configured to communicate with an outbound path of the communications device, the second voice activity detector generating at least a second voice detection signal based upon a signal in the outbound path; and
a processor, communicating with the first voice activity detector and the second voice activity detector, the processor controlling speakerphone operation to award control of a communications channel to at least one of the inbound path and the outbound path based upon at least a comparison of the first voice detection signal and the second voice detection signal and at least one of an inbound hangtime and an outbound hangtime.

74. A system according to claim 73, wherein the processor delays the awarding of control of the communications channel to the outbound channel when the inbound channel has control of the communications channel and the second voice detection signal is asserted, the delay being equal to the inbound hangtime.

75. A system according to claim 73, wherein the processor delays the awarding of control of the communications channel to the inbound channel when the outbound channel has control of the communications channel and the first voice detection signal is asserted, the delay being equal to the outbound hangtime.

76. A system according to claim 73, wherein the processor initializes at least one of the inbound hangtime and the outbound hangtime during a startup or reset operation.

77. A system according to claim 73, wherein the processor decrements at least one of the inbound hangtime and the outbound hangtime.

78. A system according to claim 73, wherein the processor increments at least one of the inbound hangtime and the outbound hangtime.

79. A system according to claim 73, wherein the first voice detection signal comprises an assertable first voice present signal and the second voice detection signal comprises an assertable second voice present signal.

80. A system according to claim 79, wherein the comparison comprises testing for the assertion of the first voice present signal and the second voice present signal.

81. A system according to claim 73, wherein the inbound path is coupled to an input transducer.

82. A system according to claim 82, wherein the input transducer comprises a microphone.

83. A system according to claim 73, wherein the outbound path is coupled to an output transducer.

84. A system according to claim 84, wherein the output transducer comprises a speaker.

85. A system according to claim 73, wherein the communications device comprises at least one of a cellular telephone, a voice-enabled network device, and a telephone device.

86. A system according to claim 73, wherein the first voice detection signal is generated by comparing at least one of a first voice signal energy and a first voice signal envelope to a first voice threshold.

87. A system according to claim 73, wherein the second voice detection signal is generated by comparing at least one of a second voice signal energy and a second voice signal envelope to a second voice threshold.

88. A system according to claim 73, wherein the signal in the inbound path comprises at least a voice signal of a local user.

89. A system according to claim 73, wherein the signal in the outbound path comprises at least a voice signal of a remote user.

90. A system according to claim 73, further comprising a comfort noise generator, the processor communicating with the comfort noise generator to generate comfort noise at selected times based on at least one of the first voice detection signal and the second voice detection signal.

91. A system according to claim 73, further comprising an echo canceller, the echo canceller being coupled to the inbound path to cancel at least a portion of the signal in the outbound path.

92. A system according to claim 73, wherein the inbound channel further comprises a speech encoder module.

93. A system according to claim 73, wherein the outbound channel further comprises a speech decoder module.

94. A system according to claim 73, further comprising an interface to a modem transmitter module.

95. A system according to claim 73, further comprising an interface to a modem receiver module.

96. A method for managing speakerphone operation in a communications device, comprising:
generating at least a first voice detection signal based upon a signal in an inbound path of the communications device;
generating at least a second voice detection signal based upon a signal in an outbound path of the communications device; and
awarding control of a communications channel to at least one of the inbound path and the outbound path based upon at least a comparison of the first voice detection signal and the second voice detection signal and at least one of an inbound hangtime and an outbound hangtime.

97. A method according to claim 96, the step of awarding control further comprises delaying the awarding of control of the communications channel to the outbound channel when the inbound channel has control of the communications channel and the second voice detection signal is asserted, the delay being equal to the inbound hangtime.

98. A method according to claim 96, wherein the step of awarding control further comprises delaying the awarding of control of the communications channel to the inbound channel when the outbound channel has control of the communications channel and the first voice detection signal is asserted, the delay being equal to the outbound hangtime.

99. A method according to claim 96, further comprising initializing at least one of the inbound hangtime and the outbound hangtime during a startup or reset operation.

100. A method according to claim 96, further comprising decrementing at least one of the inbound hangtime and the outbound hangtime.

101. A method according to claim 96, further comprising incrementing at least one of the inbound hangtime and the outbound hangtime.

102. A method according to claim 96, wherein the first voice detection signal comprises an assertable first voice present signal and the second voice detection signal comprises an assertable second voice present signal.

103. A method according to claim 102, wherein the comparison comprises testing for the assertion of the first voice present signal and the second voice present signal.

104. A method according to claim 96, wherein the inbound path is coupled to an input transducer.

105. A method according to claim 104, wherein the input transducer comprises a microphone.

106. A method according to claim 96, wherein the outbound path is coupled to an output transducer.

107. A method according to claim 106, wherein the output transducer comprises a speaker.

108. A method according to claim 96, wherein the communications device comprises at least one of a cellular telephone, a voice-enabled network device, and a telephone device.

109. A method according to claim 96, wherein the first voice detection signal is generated by comparing at least one of a first voice signal energy and a first voice signal envelope to a first voice threshold.

110. A method according to claim 96, wherein the second voice detection signal is generated by comparing at least one of a second voice signal energy and a second voice signal envelope to a second voice threshold.

111. A method according to claim 96, wherein the signal in the inbound path comprises at least a voice signal of a local user.

112. A method according to claim 96, wherein the signal in the outbound path comprises at least a voice signal of a remote user.

113. A method according to claim 96, further comprising generating comfort noise at selected times based on at least one of the first voice detection signal and the second voice detection signal.

114. A method according to claim 96, further comprising canceling at least a portion of the signal in the outbound path.

115. A method according to claim 96, wherein the inbound channel further comprises a speech encoder module.

116. A method according to claim 96, wherein the outbound channel further comprises a speech decoder module.

117. A method according to claim 96, further comprising transmitting a signal to a modem transmitter module.

118. A method according to claim 96, further comprising receiving a signal from a modem receiver module.

119. A system for managing speakerphone operation in a communications device, comprising:
first executable code, configured to receive input from an inbound path of the communications device, the first executable code generating at least a first voice detection signal based upon a signal in the inbound path;
second executable code, configured to receive input from an outbound path of the communications device, the second executable code generating at least a second voice detection signal based upon a signal in the outbound path; and
third executable code, the third executable code controlling at least one of the inbound path and the outbound path based upon at least a comparison of the first voice detection signal and the second voice detection signal and at least one of an inbound hangtime and an outbound hangtime.

120. A communications system, comprising:
a communications device, the communications device comprising
a first voice activity detector, configured to communicate with an inbound path, the first voice activity detector generating at least a first voice detection signal based upon a signal in the inbound path,
a second voice activity detector, configured to communicate with the outbound path, the second voice activity detector generating at least a second voice detection signal based upon a signal in the outbound path, and
a processor, communicating with the first voice activity detector and the second voice activity detector, the processor controlling at least one of the inbound path and the outbound path based upon at least a comparison of the first voice detection signal and the second voice detection signal and at least one of an inbound hangtime and an outbound hangtime;
a transceiver; and
a wireless channel, coupled to the transceiver, the wireless channel configured to communicate with the inbound path and the outbound path of the communications device.

121. A system for managing speakerphone operation in a communications device, comprising:
voice activity detection means, communicating with each of an inbound path and an outbound path each of the communications device, the voice activity detection means generating at least a first voice detection signal based upon a signal in the inbound path and at least a second voice detection signal based upon a signal in the outbound path; and
processing means, configured to communicate with the voice activity detection means, the processing means controlling at least one of the inbound path and the outbound path based upon at least one of the first voice detection signal and the second voice detection signal and at least one of an inbound hangtime and an outbound hangtime.

122. A system for managing speakerphone operation in a communications device, comprising:
executable voice activity detection code, receiving input from each of an inbound path and an outbound path each of the communications device, the executable voice activity detection code generating at least a first voice detection signal based upon a signal in the inbound path and at least a second voice detection signal based upon a signal in the outbound path; and
a processor, configured to interface with the executable voice activity detection code, the processor controlling at least one of the inbound path and the outbound path based upon at least one of the first voice detection signal and the second voice detection signal and at least one of an inbound hangtime and an outbound hangtime.

123. A system for managing speakerphone operation in a communications device, comprising:
a processor, the processor being configured to execute
voice activity detection code, receiving input from each of an inbound path and an outbound path each of the communications device, the executable voice activity detection code generating at least a first voice detection signal based upon a signal in the inbound path and at least a second voice detection signal based upon a signal in the outbound path, and
arbitration code, the arbitration code controlling at least one of the inbound path and the outbound path based upon at least one of the first voice detection signal and the second voice detection signal and at least one of an inbound hangtime and an outbound hangtime.

124. A system for managing speakerphone operation in a communications device, comprising:
a first voice activity detector, configured to communicate with an inbound path of the communications device, the first voice activity detector generating at least a first voice detection signal based upon a signal in the inbound path, the first voice detection signal comprising at least an assertable first voice present signal;
a second voice activity detector, configured to communicate with an outbound path of the communications device, the second voice activity detector generating at least a second voice detection signal based upon a signal in the outbound path; and
a processor, communicating with the first voice activity detector and the second voice activity detector, the processor controlling speakerphone operation to transition control of a communications channel from the outbound path to the inbound path only when the first voice present signal is asserted.

125. A system according to claim 124, wherein the inbound path is coupled to an input transducer.

126. A system according to claim 125, wherein the input transducer comprises a microphone.

127. A system according to claim 124, wherein the outbound path is coupled to an output transducer.

128. A system according to claim 127, wherein the output transducer comprises a speaker.

129. A system according to claim 124, wherein the communications device comprises at least one of a cellular telephone, a voice-enabled network device, and a telephone device.

130. A system according to claim 124, wherein the first voice detection signal is generated by comparing at least one of a first voice signal energy and a first voice signal envelope to a first voice threshold.

131. A system according to claim 124, wherein the signal in the inbound path comprises at least a voice signal of a local user.

132. A system according to claim 124, wherein the signal in the outbound path comprises at least a voice signal of a remote user.

133. A system according to claim 124, further comprising a comfort noise generator, the processor communicating with the comfort noise generator to generate comfort noise at selected times based on at least one of the first voice detection signal and the second voice detection signal.

134. A system according to claim 124, further comprising an echo canceller, the echo canceller being coupled to the inbound path to cancel at least a portion of the signal in the outbound path.

135. A system according to claim 124, wherein the inbound channel further comprises a speech encoder module.

136. A system according to claim 124, wherein the outbound channel further comprises a speech decoder module.

137. A system according to claim 124, further comprising an interface to a modem transmitter module.

138. A system according to claim 124, further comprising an interface to a modem receiver module.

139. A method for managing speakerphone operation in a communications device, comprising:
generating at least a first voice detection signal based upon a signal in an inbound path of the communications device, the first voice detection signal comprising at least an assertable first voice present signal;
generating at least a second voice detection signal based upon a signal in an outbound path of the communications device; and
transitioning control of a communications channel from the outbound path to the inbound path only when the first voice present signal is asserted.

140. A method according to claim 139, wherein the inbound path is coupled to an input transducer.

141. A method according to claim 140, wherein the input transducer comprises a microphone.

142. A method according to claim 139, wherein the outbound path is coupled to an output transducer.

143. A method according to claim 143, wherein the output transducer comprises a speaker.

144. A method according to claim 139, wherein the communications device comprises at least one of a cellular telephone, a voice-enabled network device, and a telephone device.

145. A method according to claim 139, wherein the first voice detection signal is generated by comparing at least one of a first voice signal energy and a first voice signal envelope to a first voice threshold.

146. A method according to claim 139, wherein the signal in the inbound path comprises at least a voice signal of a local user.

147. A method according to claim 139, wherein the signal in the outbound path comprises at least a voice signal of a remote user.

148. A method according to claim 139, further comprising generating comfort noise at selected times based on at least one of the first voice detection signal and the second voice detection signal.

149. A method according to claim 139, further comprising canceling at least a portion of the signal in the outbound path.

150. A method according to claim 139, wherein the inbound channel further comprises a speech encoder module.

151. A method according to claim 139, wherein the outbound channel further comprises a speech decoder module.

152. A method according to claim 139, further comprising transmitting a signal to a modem transmitter module.

153. A method according to claim 139, further comprising receiving a signal from a modem receiver module.

154. A system for managing speakerphone operation in a communications device, comprising:
first executable code, configured to receive input from an inbound path of the communications device, the first executable code generating at least a first voice detection signal based upon a signal in the inbound path, the first voice detection signal comprising at least an assertable first voice present signal;
second executable code, configured to receive input from an outbound path of the communications device, the second executable code generating at least a second voice detection signal based upon a signal in the outbound path; and
third executable code, the third executable code transitioning control of a communications channel from the outbound path to the inbound path only when the first voice present signal is asserted.

155. A communications system, comprising:
a communications device, the communications device comprising
a first voice activity detector, configured to communicate with an inbound path, the first voice activity detector generating at least a first voice detection signal based upon a signal in the inbound path, the first voice detection signal comprising at least an assertable first voice present signal,
a second voice activity detector, configured to communicate with an outbound path, the second voice activity detector generating at least a second voice detection signal based upon a signal in the outbound path, and
a processor, communicating with the first voice activity detector and the second voice activity detector, the processor transitioning control of a communications channel from the outbound path to the inbound path only when the first voice present signal is asserted;
a transceiver; and
a wireless channel, coupled to the transceiver, the wireless channel configured to communicate with the inbound path and the outbound path of the communications device.

156. A system for managing speakerphone operation in a communications device, comprising:
voice activity detection means, communicating with each of an inbound path and an outbound path each of the communications device, the voice activity detection means generating at least a first voice detection signal based upon a signal in the inbound path, the first voice detection signal comprising at least an assertable first voice present signal, and at least a second voice detection signal based upon a signal in the outbound path; and
processing means, configured to communicate with the voice activity detection means, the processing means transitioning control of a communications channel from the outbound path to the inbound path only when the first voice present signal is asserted.

157. A system for managing speakerphone operation in a communications device, comprising:
executable voice activity detection code, receiving input from each of an inbound path and an outbound path each of the communications device, the executable voice activity detection code generating at least a first voice detection signal based upon a signal in the inbound path, the first voice detection signal comprising at least an assertable first voice present signal, and at least a second voice detection signal based upon a signal in the outbound path; and
a processor, configured to interface with the executable voice activity detection code, the processor transitioning control of a communications channel from the outbound path to the inbound path only when the first voice present signal is asserted.

158. A system for managing speakerphone operation in a communications device, comprising:
a processor, the processor being configured to execute
voice activity detection code, receiving input from each of an inbound path and an outbound path each of the communications device, the executable voice activity detection code generating at least a first voice detection signal based upon a signal in the inbound path, the first voice detection signal comprising at least an assertable first voice present signal, and at least a second voice detection signal based upon a signal in the outbound path, and
arbitration code, configured to communicate with the voice activity detection code, the arbitration code transitioning control of a communications channel from the outbound path to the inbound path only when the first voice present signal is asserted.

159. An accessory system for enabling the management of speakerphone operation in a communications device, comprising:
a coupleable interface to the communications device;
a first voice activity detector, configured to communicate with an inbound path of the communications device, the first voice activity detector generating at least first voice data based upon a signal in the inbound path;
a second voice activity detector, configured to communicate with an outbound path of the communications device, the second voice activity detector generating at least second voice data based upon a signal in the outbound path; and
a processor, communicating with the first voice activity detector and the second voice activity detector, the processor controlling at least one of the inbound path and the outbound path based upon at least one of the first voice data and the second voice data.

160. A system according to claim 159, wherein the accessory system comprises a battery system coupleable to the communications device.

161. A system according to claim 160, wherein the battery system comprises a microphone.

162. A system according to claim 160, wherein the battery system comprises a speaker.

163. A system according to claim 159, wherein the accessory system comprises a coupleable transducer.

164. A system according to claim 163, wherein the coupleable transducer comprises a headset device.

165. A system according to claim 164, wherein the headset device comprises a microphone.

166. A system according to claim 164, wherein the headset device comprises a speaker.

167. A system according to claim 163, wherein the coupleable transducer comprises a tabletop unit.

168. A system according to claim 167, wherein the tabletop unit comprises a microphone.

169. A system according to claim 167, wherein the tabletop unit comprises a speaker.

170. A system according to claim 167, wherein the coupleable interface comprises at least one of a serial interface, a parallel interface, an infrared interface and a radio frequency interface.

171. A method for enabling the management of speakerphone operation in a communications device using an accessory system, comprising:
coupling the accessory system to the communications device;
generating at least first voice data based upon a signal in an inbound path of the communications device;
generating at least second voice data based upon a signal in an outbound path of the communications device; and
controlling at least one of the inbound path and the outbound path based upon at least one of the first voice data and the second voice data.

172. A method according to claim 171, wherein the accessory system comprises a battery system coupleable to the communications device.

173. A method system according to claim 172, wherein the battery system comprises a microphone.

174. A method according to claim 172, wherein the battery system comprises a speaker.

175. A method according to claim 171, wherein the accessory system comprises a coupleable transducer.

176. A method according to claim 175, wherein the coupleable transducer comprises a headset device.

177. A method according to claim 176, wherein the headset device comprises a microphone.

178. A method according to claim 176, wherein the headset device comprises a speaker.

179. A method according to claim 176, wherein the coupleable transducer comprises a tabletop unit.

180. A method according to claim 179, wherein the tabletop unit comprises a microphone.

181. A method according to claim 179, wherein the tabletop unit comprises a speaker.

182. A method according to claim 171, wherein the step of coupling comprises coupling via at least one of a serial interface, a parallel interface, an infrared interface and a radio frequency interface.
